(19) United States
(12) Patent Application Publication
(10) Pub. No.: US 2026/0172717 A1
(43) Pub. Date: Jun. 18, 2026

(54) Barrier Threshold-Based Read Out Circuit for Pinned Photodiode

(71) Applicant: Attollo Engineering, LLC, Camarillo, CA (US)

(72) Inventor: Justin Wehner, Goleta, CA (US)

(21) Appl. No.: 18/980,344

(22) Filed: Dec. 13, 2024

(51) Int. Cl. H04N 25/78

(52) U.S. Cl. CPC H04N 25/78

(57) ABSTRACT

A read circuit configured to detect a charge stored in a charge storage well includes a counter circuit. The counter circuit is configured to measure a charge collected in the charge storage well based on a number of times the charge storage well is filled. The counter circuit is further configured to lower a barrier threshold of a transfer gate associated with the charge storage well. The counter circuit is configured to receive the charge and increment a count when a charge accumulates in the charge storage well that is sufficient to overcome the lowered barrier threshold

### TECHNICAL FIELD OF THE INVENTION

This disclosure relates to photodetector systems and more specifically, to techniques for reading a charge transfer style photodetector such as a pinned photodiode.

### BACKGROUND

Photodetectors are commonly used as a sensor in many applications to measure incident light. For example, a photodetector may be used to measure light reflected from an object to, for example, determine surface reflectance properties or detect objects in a scene being illuminated by the light source or otherwise emitting photons.

Some examples of photodetectors are charge transfer types of semiconductor devices that implement a pinned photodiode (PPD) or other similar structure that is used to convert light into an electrical signal. Such devices may be used in image sensors, such as charge-coupled devices (CCDs), complementary metal-oxide-semiconductor (CMOS) sensors, or other types of image or light detection sensors. A pinned photodiode may include a floating junction that is electrically isolated until read-out. One advantage of a pinned photodiode is the reduction of noise, which may improve image quality.

Traditional read circuits for photodetectors with a pinned photodiode or other type of charge transfer style detector structure convert a collected charge (generated by light) into a usable electrical signal. The process typically involves transferring the charge from the photodiode to a read circuit via the floating diffusion.

A need exists for improvements in readout circuits that convert a charge collected by a pinned photodiode or other type of charge transfer detector that is relatively easy or inexpensive to implement and/or operate effectively to measure high dynamic ranges of incident light.

### SUMMARY

In some aspects, a read circuit includes a counter circuit configured to measure a charge collected by a charge storage well of a pinned photodiode based on a number of times the charge storage well is filled.. The counter circuit is configured to lower a barrier threshold of a transfer gate associated with the charge storage well, receive the charge, and increment a count when a charge accumulates in the charge storage well that is sufficient to overcome the lowered barrier threshold.

In some aspects, a method includes operating a counter circuit to measure a charge collected by a charge storage well based on a number of times the charge storage well is filled. The method further includes lowering a barrier threshold of a transfer gate associated with the charge storage well. The method further includes receiving the charge and incrementing a count when a charge accumulates in the charge storage well that is sufficient to overcome the lowered barrier threshold.

In some aspects, a system is described that includes a pinned photodiode that includes a charge storage well and a transfer gate, and a read circuit that includes a counter circuit. The counter circuit is configured to measure a charge collected by a charge storage well of the pinned photodiode based on a number of times the charge storage well is filled. The counter circuit is configured to lower a barrier threshold of the transfer gate, and receive the charge and increment a count when a charge accumulates in the charge storage well that is sufficient to overcome the lowered barrier threshold.

### BRIEF DESCRIPTION OF THE DRAWINGS

FIG. 1 is a circuit diagram that depicts one example of a photodetector system with a read circuit according to some embodiments.

FIG. 2 is a circuit diagram that depicts one example of a photodetector system with a read circuit that includes a residual circuit according to some embodiments.

FIG. 3 is a timing diagram that depicts a potential at a transfer gate of a photodiode that includes a pinned photodetector according to some embodiments.

FIG. 4 is a flow diagram depicting a method of operating a read circuit according to some embodiments.

### DETAILED DESCRIPTION

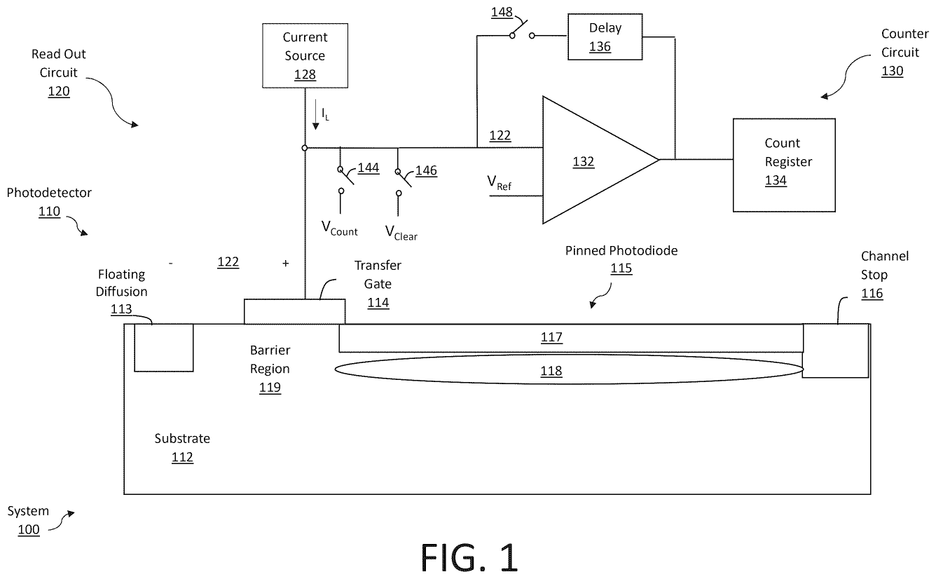

FIG. 1 is a circuit diagram that depicts one example of a photodetector system 100 that includes a photodetector 110 and a read circuit 120 in some embodiments. The photodetector 110 is a charge transfer style photodetector that includes a pinned photodiode 115. As shown in FIG. 1, the photodetector 110 includes a substrate 112, which may be a p-type substrate, though opposite polarity architectures are possible. As shown in FIG. 1, a charge storage well 117, which may be n-type region where the substrate is p-type (forming a pinned photodiode), is formed above the substrate 112 and serves to store a charge responsive to optical energy incident on the photodetector 110 (e.g., light incident on the substrate 112). Other forms of charge storage well formation such as charge-coupled devices may also be considered by those skilled in the art. The photodetector 110 also includes a depletion region 118 at a boundary between the substrate 112 and the charge storage well 117. A channel stop 116 may serve as an end of the charge storage well 117. When optical energy hits the photodetector 110 incident photons create electron-hole pairs, the depletion region 118 separates the carriers, which are collected in the charge storage well 117.

As also shown in FIG. 1, the photodetector 110 includes a transfer gate 114, a floating diffusion 113, and a barrier region 119 arranged underneath the transfer gate 114. The barrier region 119 may be an n-doped region in substrate 112 where the substrate is p-type. In some examples, the transfer gate 114 includes an electrical contact that is used to move carriers (i.e., electrons or holes) from the charge well 117 for readout. In some examples, the floating diffusion 113 is a separate electrical contact that operates as a storage element to store carriers after being transferred through the transfer gate 114. In some examples, the barrier region 119 operates as a charge barrier that prevents movement of electrons from the charge well 117 to the floating diffusion 113 and/or the read circuit 120, depending on the potential of the transfer gate. In some examples, an amount of charge in the charge storage well 117 that must be exceeded for the charge to be transferred past the charge barrier may be referred to as a barrier threshold of the photodetector 110.

In a traditional photodetector system, the charge barrier ensures that a charge stays in the charge storage well until the transfer gate is activated (i.e., by a pulse applied to the transfer gate), and once activated, the charge in the charge storage well flows until it is transferred from the well via the floating diffusion to an external capacitor to be translated to a voltage by the read circuit. A transfer occurs for each frame, and the charge collected represents a pixel. After read-out the circuit is reset (e.g., by resetting the floating diffusion and/or the transfer gate to a known potential).

The read circuit 120 depicted in FIG. 1 is uniquely configured to read a charge from the pinned photodiode 115 through the floating diffusion 113 without using an external capacitor as a storage element and/or without activating the transfer gate 114 to initiate charge transfer. Instead, the read circuit 120 includes a counter circuit 130 that is configured to measure a charge collected by the charge storage well 117 of the pinned photodiode 115 based on a count. The counter circuit 130 is configured to manipulate the charge barrier of the barrier region 119 to control the transfer of charge from the charge storage well 117 to the read circuit 120.

As shown in FIG. 1, the read circuit 120 includes a current source 128 that injects a current into (or from, depending on the polarity of the device) the transfer gate 114 in response to leakage across the barrier region 119. For example, the current source 128 may be a circuit configured to multiply or otherwise amplify the leakage current across the barrier threshold. The current source 128 may be described as a current dependent current source that causes the leakage current I_{L} to be multiplied, The multiplied leakage current I_{L} may lower the barrier threshold, thereby reducing a level of charge at which the charge barrier is exceeded, further increasing the leakage from the charge storage well 117, so that carriers flow to the read circuit 120 from the charge well 117 to be measured. In some examples, the current source 128 is a negative (−M) current mirror. In some examples, the current source 128 may include a charge multiplier circuit. With the barrier threshold lowered as described, when sufficient charge collects in the charge well 117, it is automatically transferred to the read circuit 120 without activating the transfer gate 114 (e.g., without apply a pulse to activate the transfer gate 114). In this manner, the read circuit 120 may be implemented with reduced complexity in comparison to traditional read circuits for a charge transfer style photodiode, as one or more of activating the transfer gate and/or implementing an external capacitor may not be needed.

As shown in the FIG. 1 example, the counter circuit 130 includes a reset switch 144, a clear switch 146, a floating diffusion switch 142, a comparator 132, and a count register 134. In operation, the counter circuit 130 is operable to quantify optical energy detected by the photodetector 110 based on a count value. For example, counter circuit 130 may initiate a counting process by first operating the V_{Clear} switch 146 to apply a predefined clear voltage to the transfer gate 114. In some examples, operating the V_{Clear} switch 146 to apply a predefined clear voltage V_{Clear} clears the photodetector 110 of charge for a subsequent measurement at the end of a predetermined integration time.

After the clear voltage V_{Clear} is applied via the switches 142, 146, the current source 128 is activated to magnify a leakage current I_{L} at the transfer gate 114 to lower the charge transfer barrier of the barrier region 119. After the clear voltage V_{Clear} is applied, photons incident on the photodetector 110 may cause a charge to accumulate in the charge well 117. Once enough charge is accumulated to overcome the charge transfer barrier, carriers (i.e., electrons/holes) are transferred as the transfer gate potential 122 to a first terminal of a comparator 132, which includes a second terminal coupled to a voltage reference V_{Ref}. If the transferred charge causes the transfer gate potential 122 to be less than the voltage reference V_{Ref}, the count register 134 increments a count. To begin a subsequent count, the reset switch 144 is used to couple a voltage V_{Count} to the transfer gate 114 to prepare the transfer gate 114 for the next count. In some examples, the voltage V_{Count} may be less than the voltage V_{Clear} and clear most of the charge from the charge well 117. In some examples, the voltage V_{Count} is selectable to enable the read circuit 120 to be used with charge storage wells of different sizes.

After the transfer gate 114 is reset via the reset switch 144, the current source 128 is again activated to inject the current to the transfer gate 114, to lower the barrier threshold of the charge barrier. For example, the current source 128 may operate to magnify a leakage current at the transfer gate 114, which may cause an avalanche effect where further leakage further lowers the barrier threshold, increasing the avalanche effect. If the read circuit measures the potential 122 and it falls below the threshold V_{Ref}, the count register 134 is incremented and the photodetector 110 reset (i.e., via the voltage V_{Count} or V_{Clear} at the end of a predetermined integration time). Once the circuit counts the event and recycles the transfer gate potential charge may again accumulate in the charge well 117 until the barrier threshold is again exceeded and the charge stored in the charge well 117 is transferred to the counter circuit 130 (to the first terminal of the comparator 132 as the transfer gate potential 122). In some examples, as shown in FIG. 1, a delay 136 in a feedback path of the comparator 132 drives the switches 146 and 144 to control the timing of the reset process to allow the charge well to drain to a known level after each count.

In some examples, the counter circuit 130 may perform the measurement for a predetermined integration time, for example as defined by a clock and/or counter circuit (not shown in FIG. 1). In some examples, once the integration time has been reached, the read circuit 120 identifies an incident light level based on the stored count.

In some examples, the read circuit 120 depicted in FIG. 1 may offer significant advantages over traditional read circuits for charge transfer photodetectors that include, for example, a pinned photodetector 115 as shown in FIG. 1. For example, the read circuit 120 may be particularly adapted to quickly and efficiently detect light incident on a photodetector without requiring an external capacitor and/or without actively controlling (i.e., applying a pulse) to transfer charge from the charge well 117 to the read circuit 120. In some examples, the read circuit 120 depicted in FIG. 1 may be particularly easy, and inexpensive, to implement in comparison to traditional read circuit. In some examples, the read circuit 120 depicted in FIG. 1 may offer high dynamic range in comparison to traditional read circuits. In some examples, read circuit 120 may enable use of a large charge well with similar noise properties to a smaller charge well.

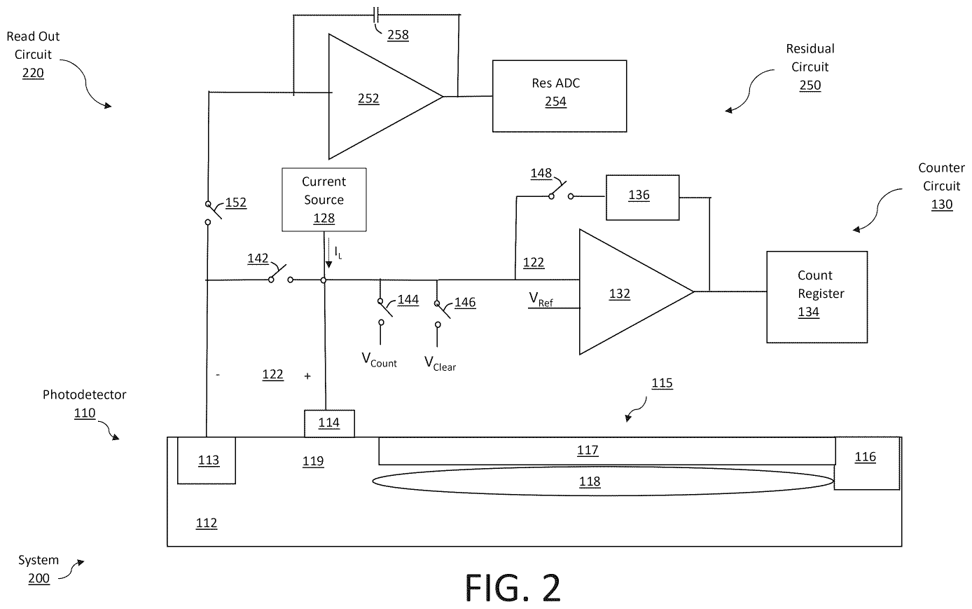

FIG. 2 is a circuit diagram that depicts one example of a photodetector system 200 with a read circuit 220 that includes a residual circuit 250 according to some embodiments. The system 200 depicted in FIG. 2 is substantially identical to system 100 depicted in FIG. 1, and includes a photodetector 110 that includes a pinned photodiode 115 and a counter circuit 130 configured to generate a count that represents a magnitude of light incident on the photodetector by manipulating a charge barrier of the photodetector. As described above with respect to FIG. 1, the counter circuit 130 is configured to lower the charge barrier, for example by injecting a current into the transfer gate 114 such that the charge barrier acts as a gate to the transfer of charge to the counter circuit 130.

The example of FIG. 2 differs from the example of FIG. 1 in that read circuit 220 includes a residual circuit 250. The residual circuit 250 includes residual switches 142, 152, an amplifier 252 including a feedback capacitor 258, and at least one analog to digital converter (ADC) 254. The residual switches 142, 152 are configured to couple the amplifier 252 to the floating diffusion 113 after an integration time has elapsed to measure a residual charge in the charge storage well 117. Accordingly, the residual switches 142, 152 may be used to transition the read circuit 220 from a count-only mode where the read circuit determines a measurement of incident light on the photodetector 110 based on a count alone, and a count and residual mode in which the read circuit 220 is operated to calculate a residual and determine a measurement of incident light base on a count and a residual measurement. In some examples, a pulse may be applied to the transfer gate 114 at substantially the same time, to cause a residual charge (a charge that remains in the charge well 117 at the end of the integration time where the charge well is not completely full) to be measured and represent an additional count (or lower significant bits) registered by the counter circuit 130 (e.g., in count register 134). The amplifier 252 is operable to amplify a voltage at the floating diffusion 113 to prepare it for sampling. As shown in FIG. 2, the output of the amplifier 252 is coupled to the ADC 254, which is operable to convert the output of the amplifier 252 to a digital value that represents the charge transferred to the residual circuit 250. In some examples, the read circuit 220 may be configured to detect light incident on the photodetector 110 with greater accuracy, by using the digital value output by the residual circuit 250 in addition to the count from the count circuit 130 to detect a magnitude of light incident on the photodetector 110. For example, the read circuit 220 may add a calculated residual to a light detection value represented by a count value from the counter circuit 130.

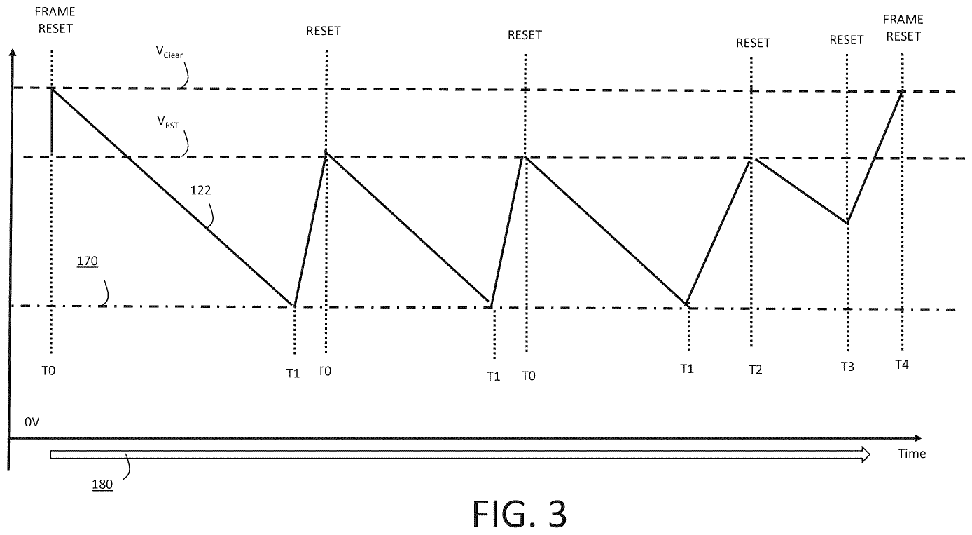

FIG. 3 is a timing diagram that depicts a potential 122 at a transfer gate 114 of a photodiode that includes a charge storage well 117 according to some embodiments. As shown in FIG. 3, at the time T0, an integration time 180 of the counter circuit 130 begins when a clear voltage V_{clear} is applied to the transfer gate 114 to reset the charge storage well 117 to clear the charge stored in the charge well 117. The FIG. 3 diagram corresponds to an implementation where the charge carriers stored in the charge well 117 and transferred to the counter circuit 130 are electrons. In other examples, the carriers may be holes, and the polarity of the FIG. 3 diagram would be reversed.

FIG. 3 also shows a barrier threshold 170. The barrier thresholds 170 correspond to a level of charge stored in the charge storage well 117 that must be overcome for charge to be transferred to the floating diffusion 113 and/or the read circuit 120, 220. As shown in FIG. 3, at the time T0 when the photodetector 110 is reset, the barrier threshold is set to level 170. Barrier level 170 may be adjustable to change the amount of charge that could be store in charge well 117 to represent one “count”.

According to the example of FIG. 3, from the time T0 when the charge storage well 117 was reset, to the time T1, a charge (i.e., electron or hole carriers) may build up in the charge well 117. During this time period,, current is applied to the transfer gate 114, for example to multiply a leakage current I_{L} from the charge storage well 117. At the time T1 in FIG. 3, once the level of charge in the charge well 117 reaches or exceeds the barrier threshold 170, the charge in the charge well 117 is transferred to the read circuit 120, for example via the transfer gate 114 and/or the floating diffusion 113. In some examples, the potential 122 of the transfer gate 114 falls when the charge in the charge well 117 is transferred to the read circuit 120, 130.

As shown in FIG. 3, the read circuit 120, 130 may continue to reset the charge storage well 117 at subsequent times T0, allow leakage to feedback to the transfer gate 114 through the current source 128, receive the charge once enough charge is collected in the storage well 117 to overcome the barrier threshold 170 at subsequent T1, and increment a count each time the transferred charge causes the potential 122 supplied to the comparator 132 to be less than a reference voltage V_{Ref}. As also shown in FIG. 3, once an integration time 180 has elapsed at the time T2, the read circuit 120 determines a measurement of light incident on the photodetector 110 during the integration time 180 based on a value of the count. In some examples, the count register(s) 134 are cleared to prepare for a next count and the charge well 117 is also cleared (e.g., via application of the clear voltage V_{Clear}) and brought back to the initial frame reset value. In the example of FIG. 3, charge was transferred to the read circuit 120 three times (to time T2, a last count before end of integration time) during the integration time 180, which may correspond to a particular magnitude or range of magnitudes of light incident on the photodetector 110.

In an optional embodiment, the read circuit may be a read circuit 220 as shown in FIG. 2 that includes a residual circuit 250 in addition to the counter circuit 130. According to these examples, as shown by the time T3 in FIG. 3, the residual circuit 250 may be coupled to the photodetector 110 (i.e., via the floating diffusion 113) to measure the residual charge after the integration time 180 has expired. For example, the residual circuit 250 may include at least one analog to digital converter ADC 254 coupled to receive an output of an amplifier 252, and generate a digital representation of the transferred residual charge. The read circuit 220 may use the residual charge, as well as the count value determined by the counter circuit 130, to determine an accurate representation of light incident on the photodetector 110, (i.e., charge stored in the charge storage well 117 due to incident light). As shown in FIG. 3, after reading the residual charge, at the time T4 the clear voltage V_{Clear} may be applied to the transfer gate 114 to clear the charge storage well 117 of charge for a subsequent measurement frame.

In the example of FIG. 3, the techniques of this disclosure, which include adjusting a barrier threshold associated with a charge barrier of a photodetector are described applied to the non-limiting example of a pinned photodiode. One of ordinary skill in the art that the techniques described herein may be applied to any photodiode which includes an inherent charge barrier and manipulate (i.e., raise or lower) that charge barrier to repetitively transfer a charge stored in the photodetector to a read circuit to implement a count.

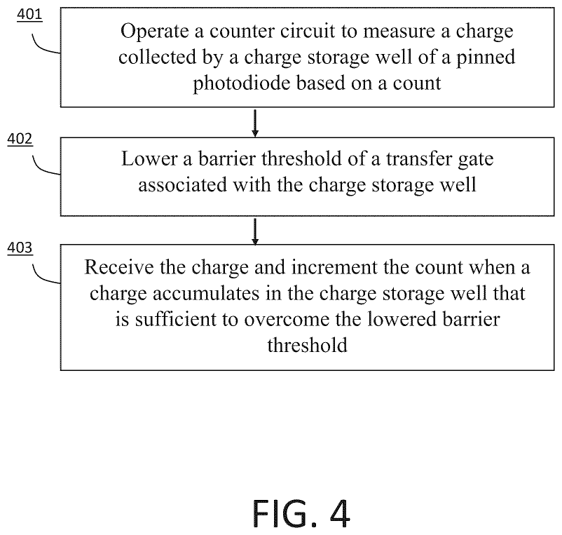

FIG. 4 is a flow diagram depicting a method of operating a read circuit according to some embodiments. The method may be performed by the read circuit 120 depicted in FIG. 1, the read circuit 220 depicted in FIG. 2, or any other read circuit. As shown in FIG. 4, at 401, the method includes operating a counter circuit 130 to measure a charge collected by a charge storage well 117 of a pinned photodiode 115 based on a count. As shown in FIG. 4, at 402, the method further includes lowering a barrier threshold (170) of a transfer gate 114 associated with the charge storage well 117. As shown in FIG. 4, at 403, the method further includes receiving the charge and incrementing the count when a charge accumulates in the charge storage well 117 that is sufficient to overcome the barrier threshold 170.

In some examples, the method includes using at least one current source 128 to inject a current (e.g., the current I_{Bias}) into the transfer gate 114 to lower the barrier threshold. In some examples, the current source may be described as a current dependent current source that amplifies, or multiplies, a leakage current I_{L} from the charge storage well 117. In some examples, the method includes using a negative current mirror as the at least one current source. In some examples, the method includes using a charge multiplier as the at least one current source. In some examples, the method includes transferring a charge in the charge well to the counter circuit after the charge exceeds the lowered barrier threshold. In some examples, the method further includes operating a residual circuit that includes an amplifier configured to be coupled to a floating diffusion of the photodetector to measure a residual charge in the charge storage well after an integration time has elapsed.

### Clauses

Clause 1. A read circuit, comprising: a counter circuit configured to measure a charge collected by a charge storage well based on a number of times the charge storage well is filled, wherein the counter circuit is configured to: lower a barrier threshold of a transfer gate associated with the charge storage well; and receive the charge and increment a count when a charge accumulates in the charge storage well that is sufficient to overcome the lowered barrier threshold.

Clause 2. The read circuit of clause 1, further comprising: at least one current source coupled to inject a current into the transfer gate to lower the barrier threshold.

Clause 3. The read circuit of any of clauses 1 and 2, wherein the at least one current source is a negative current mirror.

Clause 4. The read circuit of clause 3, wherein the at least one current source includes a charge multiplier.

Clause 5. The read circuit of any of clauses 1-4, wherein the barrier threshold is associated with a barrier region underneath the transfer gate.

Clause 6. The read circuit of any of clauses 1-5, wherein a reset potential of the transfer gate is adjustable to reset the barrier threshold.

Clause 7. The read circuit of clause 5, wherein after the charge storage well is reset, a charge accumulates in charge storage well until the charge exceeds the lowered barrier threshold.

Clause 8. The read circuit of any of clauses 1-7, wherein a charge in the charge storage well is transferred to the counter circuit after the charge exceeds the barrier threshold.

Clause 9. The read circuit of clause 8, wherein a potential of the transfer gate falls when the charge in the charge storage well is transferred to the counter circuit.

Clause 10. The read circuit of clause 9, wherein when the potential of the transfer gate falls below a threshold, a comparator increments a count register and initiates a reset of the charge storage well after a delay for a subsequent count.

Clause 11. The read circuit of any of clauses 1-10, further comprising: a residual circuit that includes an amplifier configured to be coupled to a floating diffusion after an integration time has elapsed to measure a residual charge in the charge storage well.

Clause 12. The read circuit of any of clauses 1-11, wherein the counter circuit is further configured to: clear the charge storage well of charge for a subsequent measurement at an end of an integration time.

Clause 13. A method, comprising: operating a counter circuit to measure a charge collected by a charge storage well of a charge storage well based on a number of times the charge storage well is filled, comprising: lowering a barrier threshold of a transfer gate associated with the charge storage well; and receiving the charge and incrementing a count when a charge accumulates in the charge storage well that is sufficient to overcome the lowered barrier threshold.

Clause 14. The method of clause 13, further comprising using at least one current source to inject a current into the transfer gate to lower the barrier threshold.

Clause 15. The method of clause 14, further comprising: using a negative current mirror as the at least one current source.

Clause 16. The method of any of clauses 14 and 15, further comprising: using a charge multiplier as the at least one current source.

Clause 17. The method of any of clauses 13-16, wherein transferring a charge in the charge storage well to the counter circuit after the charge exceeds the lowered barrier threshold.

Clause 18. The method of any of clauses 13-17, further comprising: operating a residual circuit that includes an amplifier configured to be coupled to a floating diffusion to measure a residual charge in the charge storage well after an integration time has elapsed.

Clause 19. A system, comprising: a pinned photodiode that comprises a charge storage well and a transfer gate; and a read circuit that includes a counter circuit configured to measure a charge collected by a charge storage well of a charge storage well based on a number of times the charge storage well is filled, wherein the counter circuit is configured to: lower a barrier threshold of the transfer gate; and receive the charge and increment a count when a charge accumulates in the charge storage well that is sufficient to overcome the lowered barrier threshold.

Clause 20. The system of clause 19, further comprising: at least one current source coupled to inject a current into the transfer gate to lower the barrier threshold.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A read circuit, comprising:
a counter circuit configured to measure a charge collected by a charge storage well based on a number of times the charge storage well is filled, wherein the counter circuit is configured to:
lower a barrier threshold of a transfer gate associated with the charge storage well; and
receive the charge and increment a count when a charge accumulates in the charge storage well that is sufficient to overcome the lowered barrier threshold.

2. The read circuit of claim 1, further comprising:
at least one current source coupled to inject a current into the transfer gate to lower the barrier threshold.

3. The read circuit of claim 2, wherein the at least one current source is a negative current mirror.

4. The read circuit of claim 2, wherein the at least one current source includes a charge multiplier.

5. The read circuit of claim 1, wherein the barrier threshold is associated with a barrier region underneath the transfer gate.

6. The read circuit of claim 1, wherein a reset potential of the transfer gate is adjustable to reset the barrier threshold.

7. The read circuit of claim 5, wherein after the charge storage well is reset, a charge accumulates in the charge storage well until the charge exceeds the barrier threshold.

8. The read circuit of claim 1, wherein a charge in the charge storage well is transferred to the counter circuit after the charge exceeds the barrier threshold.

9. The read circuit of claim 8, wherein a potential of the transfer gate falls when the charge in the charge storage well is transferred to the counter circuit.

10. The read circuit of claim 9, wherein when the potential of the transfer gate falls below a threshold, a comparator increments a count register and initiates a reset of the charge storage well after a delay for a subsequent count.

11. The read circuit of claim 1, further comprising:
a residual circuit that includes an amplifier configured to be coupled to a floating diffusion after an integration time has elapsed to measure a residual charge in the charge storage well.

12. The read circuit of claim 1, wherein the counter circuit is further configured to:
clear the charge storage well of charge for a subsequent measurement at an end of an integration time.

13. A method, comprising:
operating a counter circuit to measure a charge collected by a charge storage well based on a number of times the charge storage well is filled, comprising:
lowering a barrier threshold of a transfer gate associated with the charge storage well; and
receiving the charge and incrementing the count when a charge accumulates in the charge storage well that is sufficient to overcome the lowered barrier threshold.

14. The method of claim 13, further comprising
using at least one current source to inject a current into the transfer gate to lower the barrier threshold.

15. The method of claim 14, further comprising:
using a negative current mirror as the at least one current source.

16. The method of claim 14, further comprising:
using a charge multiplier as the at least one current source.

17. The method of claim 13, wherein transferring a charge in the charge storage well to the counter circuit after the charge exceeds the lowered barrier threshold.

18. The method of claim 13, further comprising:
operating a residual circuit that includes an amplifier configured to be coupled to a floating diffusion to measure a residual charge in the charge storage well after an integration time has elapsed.

19. A system, comprising:
a pinned photodiode that comprises a charge storage well and a transfer gate; and
a read circuit that includes a counter circuit configured to measure a charge collected by a charge storage well of the pinned photodiode based on a number of times the charge storage well is filled, wherein the counter circuit is configured to:
lower a barrier threshold of the transfer gate; and
receive the charge and increment the count when a charge accumulates in the charge storage well that is sufficient to overcome the lowered barrier threshold.

20. The system of claim 19, further comprising:
at least one current source coupled to inject a current into the transfer gate to lower the barrier threshold.
